(19) United States
(12) Patent Application Publication
(10) Pub. No.: US 2020/0317562 A1
(43) Pub. Date: Oct. 8, 2020

(54) WINDOW AND ELECTRONIC DEVICE CONTAINING SAME

(71) Applicant: Samsung Electronics Co., Ltd., Suwon-si, Gyeonggi-do (KR)

(72) Inventors: Minsung LEE, Suwon-si (KR); Sangin BAEK, Suwon-si (KR); Jaeho KANG, Suwon-si (KR); Wonhee CHOI, Suwon-si (KR); Minwoo YOO, Suwon-si (KR); Byounguk YOON, Suwon-si (KR); Jongchul CHOI, Suwon-si (KR)

(21) Appl. No.: 15/733,283

(22) PCT Filed: Feb. 14, 2019
(86) PCT No.: PCT/KR2019/001848

§ 371 Date: Jun. 19, 2020

(30) Foreign Application Priority Data
Feb. 23, 2018 (KR) 10-2018-0022087

(51) Int. Cl. C03C 17/00; C03C 17/34; C03C 23/00

(52) U.S. Cl. CPC C03C 17/001; G02B 1/14; C03C 23/00; C03C 17/34

(57) ABSTRACT

Introduced is an electronic device comprising: a window having a curved surface at an edge portion thereof; a housing on which the window is seated; and a reinforcing coating layer surrounding at least a portion of the surface of the window, wherein the window comprises: a first surface on which contact is made with a user; a second surface opposite to the first surface; and a third surface for connecting the first surface and the second surface, wherein the housing is configured to cover the third surface of the window, and the reinforcing coating layer is configured to surround at least the third surface of the window. Various other embodiments are possible.

### CROSS-REFERENCE TO RELATED APPLICATIONS

This application is a 371 National Stage of International Application No. PCT/KR2019/001848, filed Feb. 14, 2019, which claims priority to Korean Patent Application No. 10-2018-0022087, filed Feb. 23, 2018, the disclosures of which are herein incorporated by reference in their entirety.

### BACKGROUND

### 1. Field

Various embodiments of the disclosure relate to a coating layer for protecting a window of an electronic device.

### 2. Description of Related Art

An electronic device employs a window having a 3-dimensional curved shape to realize an appealing external appearance and an excellent gripping sensation. Technologies for forming a protective layer that can protect a window of a 3-dimensional curved shape by covering the entire area of the window and preventing the protective layer from being separated from the window have been developed.

### SUMMARY

When a conventional protective film is attached to a curved window, it is difficult to produce the window such that the protective film corresponds to the entire area of the window, it is difficult to attach the protective film to the window, and the intrinsic elastic restoring force of the protective film attached to the curved portion may weaken the bonding force of the protective film, causing removal of the protective film.

Various embodiments of the disclosure may provide a tempered window, in which a tempered coating layer, capable of uniformly protecting the entire area of a window and a curved portion thereof, is disposed, and an electronic device including the same.

In accordance with an aspect of the disclosure, a tempered window includes a window having a curved portion at an outer portion thereof, and a tempered coating layer surrounding at least a portion of a surface of the window, wherein the window includes a first surface, to which a contact of a user is input, a second surface that is opposite to the first surface, and a third surface connecting the first surface and the second surface, wherein the tempered coating layer is disposed to surround at least the third surface of the window.

In accordance with another aspect of the disclosure, an electronic device includes a window, a housing in which the window is seated, and a tempered coating layer surrounding at least a portion of a surface of the window, wherein the window includes a first surface exposed to the outside, a second surface that is opposite to the first surface, and a third surface connecting the first surface and the second surface, wherein the housing is disposed to hide at least a portion of the third surface, and wherein the tempered coating layer is disposed to surround at least the third surface of the window.

The tempered window according to an embodiment of the disclosure can protect the entire area of the window by forming the tempered coating layer in the tempered glass in a dipping scheme, and can prevent the tempered coating layer from being removed from the window, including a curved portion thereof.

The tempered window according to an embodiment of the disclosure can endure an external impact delivered through the housing without being damaged, by forming the tempered coating layer even on a surface corresponding to the thickness portion of the window.

The tempered window according to an embodiment of the disclosure can further improve the durability of the tempered window by using the tempered glass through heat treatment of the window.

### BRIEF DESCRIPTION OF THE DRAWINGS

FIG. 1 is a perspective view of a front surface of a mobile electronic device including a tempered window according to an embodiment of the disclosure;

FIG. 2 is a perspective view of a rear surface of the electronic device of FIG. 1;

FIG. 3 is an exploded perspective view of the electronic device of FIG. 1;

FIG. 4 is a view of a tempered window according to an embodiment of the disclosure;

FIG. 5 is a cross-sectional view of a tempered window according to an embodiment of the disclosure;

FIG. 6 is a cross-sectional view of an electronic device including a tempered window according to an embodiment of the disclosure;

FIG. 7 is a cross-sectional view of an electronic device including a tempered window according to another embodiment of the disclosure;

FIG. 8 is a cross-sectional view of a tempered window according to another embodiment of the disclosure;

FIG. 9 is a cross-sectional view of a tempered window according to another embodiment of the disclosure;

FIG. 10 is a cross-sectional view of an electronic device including a tempered window according to another embodiment of the disclosure;

FIG. 11 is a cross-sectional view of a tempered window according to another embodiment of the disclosure;

FIG. 12 is a cross-sectional view of an electronic device including a tempered window according to another embodiment of the disclosure;

FIG. 13 is a cross-sectional view of a tempered window according to another embodiment of the disclosure;

FIG. 14 is a flowchart illustrating a machining operation of a tempered window according to an embodiment of the disclosure;

FIG. 15 is a view illustrating a window fixing member according to an embodiment of the disclosure;

FIG. 16 is a view illustrating a masking tape and a masking film according to an embodiment of the disclosure;

FIG. 17 is a view illustrating a state in which a window is fixed to a window fixing member to coat the tempered window according to the embodiment of FIG. 5;

FIG. 18 is a view illustrating a state in which a window is fixed to a window fixing member to coat the tempered window according to the embodiment of FIG. 8; and

FIG. 19 is a view illustrating a state in which a window is fixed to a window fixing member to coat the tempered window according to the embodiment of FIG. 11.

### DETAILED DESCRIPTION

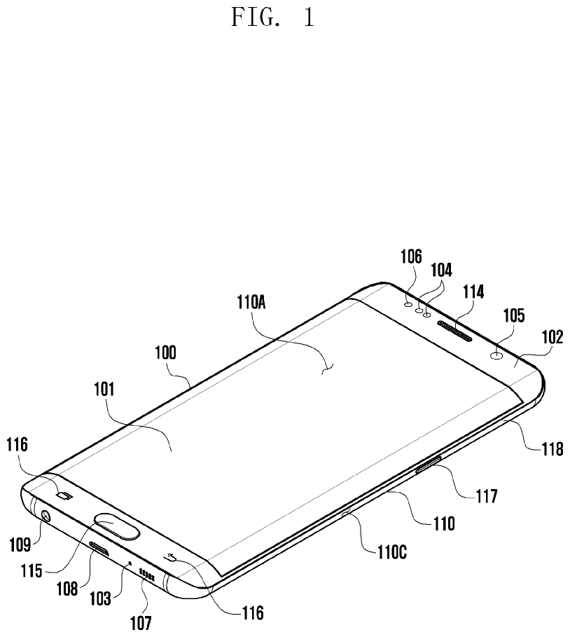

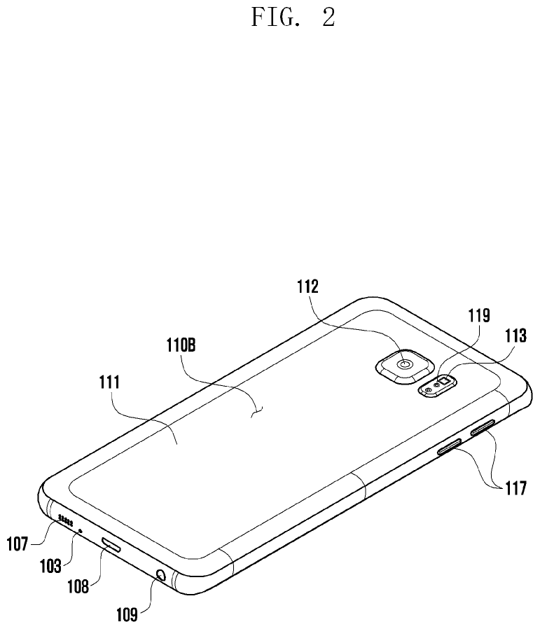

Referring to FIG. 1 and FIG. 2, an electronic device 100 according to an embodiment may include a housing 110 including a first surface (or front surface) 110A, a second surface (or rear surface) 110B, and a side surface 110C surrounding the space between the first surface 110A and the second surface 110B. In another embodiment (not illustrated), the housing may denote a structure that forms a part of the first surface 110A, the second surface 110B, and the side surface 110C illustrated in FIG. 1. According to an embodiment, the first surface 110A may be formed by a front plate 102, at least a part of which is substantially transparent (for example, a glass plate including various coating layers, or a polymer plate). The second surface 110B may be formed by a rear plate 111 that is substantially opaque. The rear plate 111 may be made of coated or colored glass, ceramic, polymer, metal (for example, aluminum, stainless steel (STS), or magnesium), or a combination of at least two of the above-mentioned materials. The side surface 110C may be formed by a side bezel structure (or “side member”) 118 which is coupled to the front plate 102 and to the rear plate 111, and which includes metal and/or polymer. In some embodiments, the rear plate 111 and the side bezel structure 118 may be formed integrally and may include the same material (for example, a metal material such as aluminum).

In the illustrated embodiment, the front plate 102 may include two first areas 110D on both ends of the long edge of the front plate 102 such that the two first areas 110D bend from the first surface 110A toward the rear plate 111 and extend seamlessly. In the illustrated embodiment (see FIG. 2), the rear plate 111 may include two second areas 110E on both ends of the long edge such that the two second areas 110E bend from the second surface 110B toward the front plate 102 and extend seamlessly. In some embodiments, the front plate 102 (or the rear plate 111) may include only one of the first areas 110D (or the second areas 110E). In another embodiment, a part of the first areas 110D or the second areas 110E may not be included. In the above embodiments, when seen from the side surface of the electronic device 100, the side bezel structure 118 may have a first thickness (or width) on a part of the side surface, which does not include the first areas 110D or the second areas 110E as described above, and may have a second thickness that is smaller than the first thickness on a part of the side surface, which includes the first areas 110D or the second areas 110E.

According to an embodiment, the electronic device 100 may include at least one of a display 101, audio modules 103, 107, and 114, sensor modules 104, 116, and 119, camera modules 105, 112, and 113, a key input device 117, a light-emitting element 106, and connector holes 108 and 109. In some embodiments, at least one of the constituent elements (for example, the key input device 117 or the light-emitting element 106) of the electronic device 100 may be omitted, or the electronic device 100 may additionally include another constituent element.

The display 101 may be exposed through a corresponding part of the front plate 102, for example. In some embodiments, at least a part of the display 101 may be exposed through the front plate 102 that forms the first areas 110D of the side surface 110C and the first surface 110A. In another embodiment (not illustrated), the display 101 may be coupled to or arranged adjacent to a touch sensing circuit, a pressure sensor capable of measuring the intensity (pressure) of a touch, and/or a digitizer that detects a magnetic field-type stylus pen. In some embodiments, at least a part of the sensor modules 104 and 119 and/or at least a part of the key input device 115, 116, and 117 may be arranged in the first areas 110D and/or the second areas 110E.

The audio modules 103, 107, and 114 may include a microphone hole 103 and speaker holes 107 and 114. A microphone for acquiring an external sound may be arranged in the microphone hole 103, and a plurality of microphones may be arranged therein such that the direction of a sound can be sensed in some embodiments. The speaker holes 107 and 114 may include an outer speaker hole 107 and a speech receiver hole 114. In some embodiments, the speaker holes 107 and 114 and the microphone hole 103 may be implemented as a single hole, or a speaker may be included (for example, a piezoelectric speaker) without the speaker holes 107 and 114.

The sensor modules 104, 116, and 119 may generate an electric signal or a data value corresponding to the internal operating condition of the electronic device 100 or the external environment condition thereof. The sensor modules 104, 116, and 119 may include, for example, a first sensor module 104 (for example, a proximity sensor) arranged on the first surface 110A of the housing 110, and/or a second sensor module (not illustrated) (for example, a fingerprint sensor), and/or a third sensor module 119 (for example, an HRM sensor) arranged on the second surface 110B of the housing 110, and/or a fourth sensor module 116 (for example, a fingerprint sensor). The fingerprint sensor may be arranged not only on the first surface 110A (for example, the display 101) of the housing 110, but also on the second surface 110B thereof. The electronic device 100 may further include a sensor module not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or a luminance sensor 104.

The camera modules 105, 112, and 113 may include a first camera device 105 arranged on the first surface 110A of the electronic device 100, a second camera device 112 arranged on the second surface 110B thereof, and/or a flash 113. The camera devices 105 and 112 may include a single lens or a plurality of lenses, an image sensor, and/or an image signal processor. The flash 113 may include, for example, a light-emitting diode or a xenon lamp. In some embodiments, two or more lenses (an infrared camera, a wide-angle lens, and a telephoto lens) and image sensors may be arranged on a single surface of the electronic device 100.

The key input device 115, 116, and 117 may include a home key button 115 disposed on the first surface 110A of the housing 110, a touch pad 116 arranged adjacent to the home key button 115 and/or a side key button 117 disposed on the side surface 110C of the housing 110. In another embodiment, the electronic device 100 may not include a part of the above-mentioned key input device 115, 116, and 117 or the entire key input device 115, 116 and 117, and the key input device 115, 116, and 117 (not included) may be implemented in another type, such as a soft key, on the display 101.

The light-emitting element 106 may be arranged on the first surface 110A of the housing 110, for example. The light-emitting element 106 may provide information regarding the condition of the electronic device 100 in a light type, for example.

The connector holes 108 and 109 may include a first connector hole 108 capable of containing a connector (for example, a USB connector) for transmitting/receiving power and/or data to/from an external electronic device, and/or a second connector hole (for example, an earphone jack) 109 capable of containing a connector for transmitting/receiving an audio signal to/from the external electronic device.

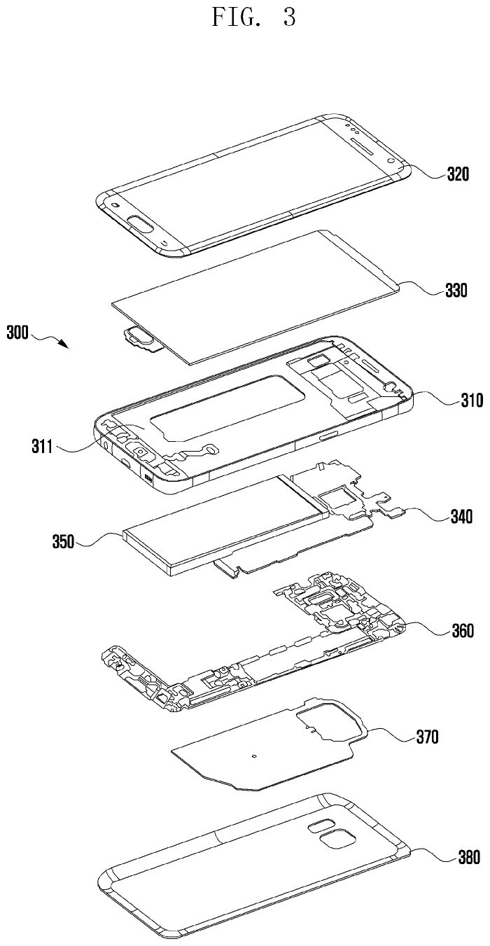

Referring to FIG. 3, the electronic device 300 may include a side bezel structure 310, a first support member 311 (for example, a bracket), a front plate 320, a display 330, a printed circuit board 340, a battery 350, a second support member 360 (for example, a rear case), an antenna 370, and a rear plate 380. In some embodiments, at least one of the constituent elements (for example, the first support member 311 or the second support member 360) of the electronic device 300 may be omitted, or the electronic device 300 may further include another constituent element. At least one of the constituent elements of the electronic device 300 may be identical or similar to at least one of the constituent elements of the electronic device 100 of FIG. 1 or FIG. 2, and repeated descriptions thereof will be omitted herein.

The first support member 311 may be arranged inside the electronic device 300 and connected to the side bezel structure 310, or may be formed integrally with the side bezel structure 310. The first support member 311 may be made of a metal material and/or a nonmetal (for example, polymer) material, for example. The display 330 may be coupled to one surface of the first support member 311, and the printed circuit board 340 may be coupled to the other surface thereof. A processor, a memory, and/or an interface may be mounted on the printed circuit board 340. The processor may include, for example, one or more of a central processing device, an application processor, a graphic processing device, an image signal processor, an sensor hub processor, or a communication processor.

The memory may include a volatile memory or a non-volatile memory, for example.

The interface may include, for example, a high definition multimedia interface (HDMI), a universal serial bus (USB) interface, an SD card interface, and/or an audio interface. The interface may connect the electronic device 300 with an external electronic device electrically or physically, for example, and may include a USB connector, an SD card/MMC connector, or an audio connector.

The battery 350 is an device for supplying power to at least one constituent element of the electronic device 300, and may include a non-rechargeable primary cell, a rechargeable secondary cell, or a fuel cell, for example. At least a part of the battery 350 may be arranged on substantially the same plane with the printed circuit board 340, for example. The battery 350 may be arranged integrally inside the electronic device 300, or may be arranged such that the same can be attached to/detached from the electronic device 300.

The antenna 370 may be arranged between the rear plate 380 and the battery 350. The antenna 370 may include, for example, a near field communication (NFC) antenna, a wireless charging antenna, and/or a magnetic secure transmission (MST) antenna. The antenna 370 may conduct near-field communication with an external device or may wirelessly transmit/receive power necessary for charging, for example. In another embodiment, an antenna structure may be formed by a part or a combination of the side bezel structure 310 and/or the first support member 311.

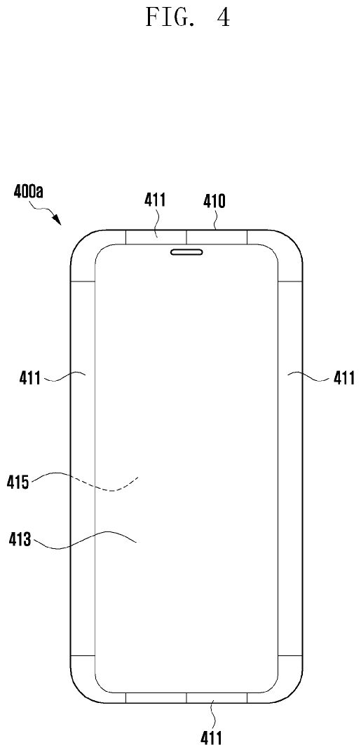

FIG. 4 is a view of a tempered window 400a according to an embodiment of the disclosure.

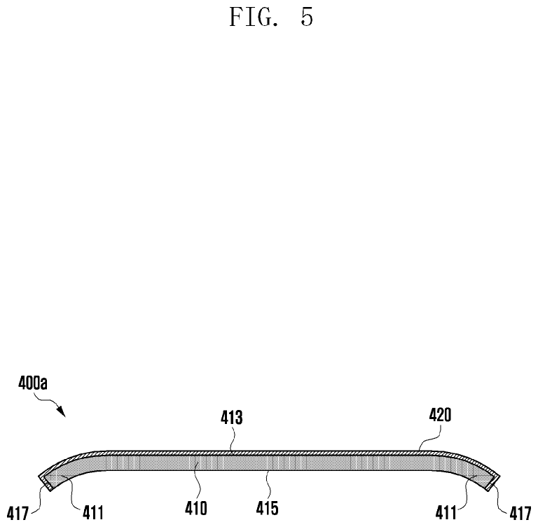

A tempered window 400a according to an embodiment of the disclosure may include a window 410 and a tempered coating layer 420 (see FIG. 5). The tempered window 400a according to an embodiment of the disclosure may be the same as or similar to a front plate 102 and 320 illustrated in FIG. 1 or FIG. 3. The window 410 may include a first surface 413, a second surface 415, and a third surface 417. FIG. 4 may be illustrated mainly with reference to the first surface 413 of the window according to an embodiment of the disclosure. The first surface 413 may be a surface that is exposed to a user, and may be a surface, on which a touch manipulation is performed by the user. The second surface 415 may be a surface that is opposite to the first surface 413, and may be a surface that faces the inside of the electronic device. The third surface 417 may be a surface corresponding to a thickness portion of the window 410 according to an embodiment of the disclosure, and is may generally refer to a side surface portion of the window 410 that connects the first surface 413 and the second surface 415.

The tempered window 400a according to an embodiment of the disclosure may have a curved surface portion 411 at an outer portion of the window 410. The disposition direction of the curved surface portion 411 may be bent from the first surface 413 toward the second surface 415. However, the bending direction of the curved surface portion 411 is not limited thereto, and the curved surface portion 411 may be bent from the second surface 415 toward the first surface 413.

FIG. 5 is a cross-sectional view of a tempered window 400a according to an embodiment of the disclosure.

FIG. 5 may be a view conceptually illustrating a cross-section obtained by cutting the tempered window 400a illustrated in FIG. 4 in a widthwise or lengthwise direction thereof. The widthwise direction may refer to a leftward/rightward direction with respect to the state illustrated in FIG. 4, and the lengthwise direction may refer to an upward/downward direction.

Referring to FIG. 5, the tempered window 400a according to an embodiment of the disclosure may include a window 410 and a tempered coating layer 420. The window 410 may include a first surface 413, a second surface 415, and a third surface 417. The first surface 413 may be a surface that is exposed to a user, and may be a surface, on which a touch manipulation is performed by the user. The second surface 415 may be a surface that is opposite to the first surface 413, and may be a surface that faces the inside of the electronic device. The third surface 417 may be a surface corresponding to a thickness portion of the window 410 according to an embodiment of the disclosure, and may generally refer to a side surface portion of the window 410 that connects the first surface 413 and the second surface 415.

The tempered coating layer 420 is configured to surround at least the third surface 417 of the first to third surfaces 413 to 417 that constitute the window 410 to reinforce the window 410.

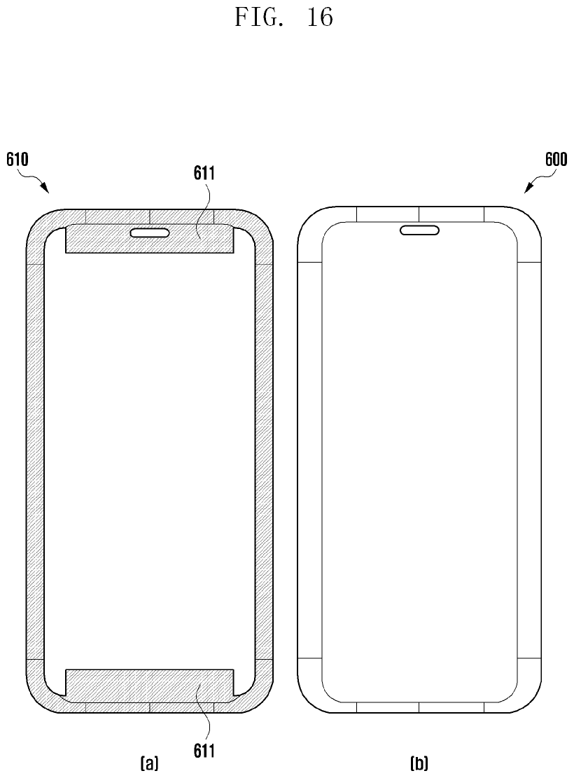

The tempered window 400a according to an embodiment of the disclosure, as illustrated in FIG. 5, may be configured to surround the first surface 413 and the third surface 417 of the window 410. The tempered coating layer 420 according to an embodiment of the disclosure may be formed through a dipping scheme of dipping and extracting the window 410 into and from a coating liquid. In the dipping operation, a masking film 600 (see FIG. 16) may be attached to a surface of the window 410, on which the tempered coating layer 420 will not be disposed. For example, in the tempered window 400a illustrated in FIG. 5, the tempered coating layer 420 may be formed on the first surface 413 and the third surface 417 by attaching a masking film 600 (see FIG. 16) to the second surface 415 of the window 410 and removing the masking film 600 (see FIG. 16) after dipping the window 410 into the coating liquid.

The tempered coating layer 420 according to an embodiment of the disclosure may also be adhered and coupled to the curved surface portion of the window 410, and the entire first surface 413 of the window 410 may be coated while the first surface 413 of the window 410 is not exposed whereby the entire window 410 can be reinforced.

The window 410 according to an embodiment of the disclosure may be formed of heat-treated tempered glass. The window 410 itself may be formed of tempered glass to increase the strength thereof, and the tempered coating layer 420 may be additionally formed to increase the durability of the tempered window 400a, by which the tempered window 400a can endure an external impact.

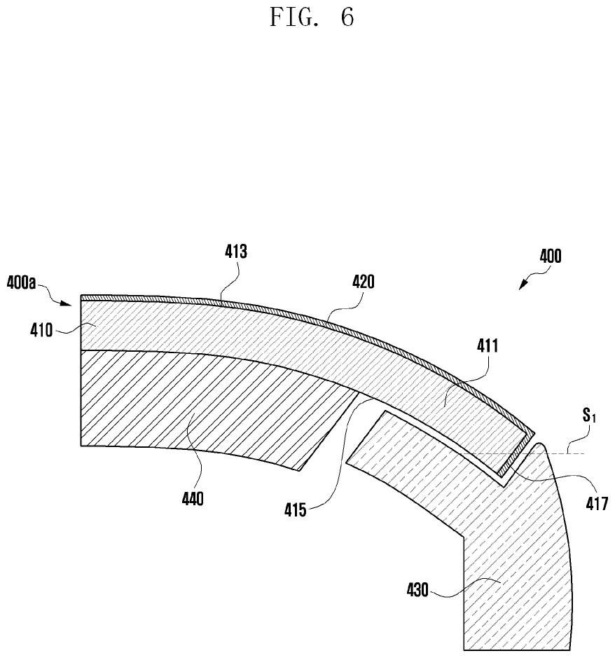

FIG. 6 is a cross-sectional view of an electronic device 400 including a tempered window 400a according to an embodiment of the disclosure.

For example, FIG. 6 may be a view conceptually illustrating a cross-section obtained by cutting the tempered window 400a in the widthwise or lengthwise direction thereof in a state in which the tempered window 400a of FIG. 5 is seated in the housing 430 of the electronic device 400. Referring to FIG. 6, the display 440 may be disposed in a partial area of the second surface 415 of the window 410 according to an embodiment of the disclosure.

The housing 430 of the electronic device 400 according to an embodiment of the disclosure may be configured to surround a portion of the curved portion of the second surface 415 of the window 410 and the third surface 417. The housing 430 may be stably seated while contacting a portion of the curved surface portion of the second surface 415 of the window 410 and may be configured to surround the third surface 417 of the window 410 to protect the window 410 from an external impact.

In a discussion of the formation relationship of the window 410, the tempered coating layer 420, and the housing 430 when an imaginary plane S1 disposed to be parallel to a flat surface of any one of the first surface 413 or the second surface 415 of the window 410 to pass the third surface of the window, the window 410, the tempered coating layer 420, and the housing 430 may be disposed in their sequence. For example, the tempered coating layer 420 may be disposed between the third surface 417 of the window 410 and the housing 430, and the tempered coating layer 420 can perform an absorption function between the window 410 and the housing 430 to absorb an impact delivered to the third surface 417 of the window 410 via the housing 430.

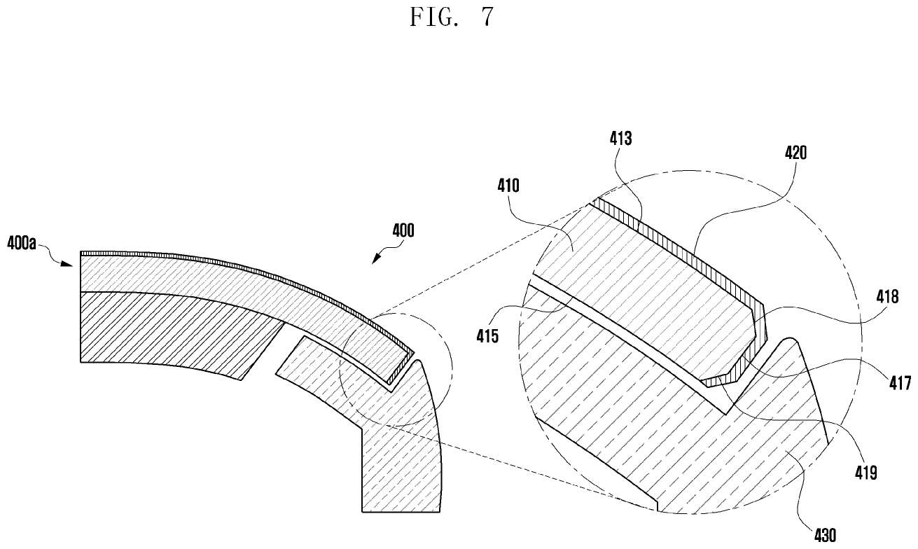

FIG. 7 is a cross-sectional view of an electronic device 400 including a tempered window 400a according to another embodiment of the disclosure.

Referring to FIG. 7, the tempered window 400a according to another embodiment of the disclosure may include a first surface 413, a second surface 415, a third surface 417, a fourth surface 418, and a fifth surface 419. The first to third surfaces 413 to 417 may be the same as those of the embodiment of FIG. 5. The fourth surface 418 may be formed by machining a corner defined by the first surface 413 and the third surface 417, and the fifth surface 419 may be formed by machining a corner defined by the second surface 415 and the third surface 417.

If the fourth surface 418 or the fifth surface 419 is formed by removing the corner defined by the first surface 413 and the third surface 417 of the window 410 and the corner defined by the second surface 415 and the third surface 417 of the window 410 through a computer numerical control (CNC), damage to the window 410 can be prevented by removing a micro crack that may be generated at a sharp corner. Further, if the tempered coating layer 420 is formed on the fourth surface 418 and the fifth surface 419, damage to the window 410 can be prevented by protecting a crack that may be left after the above-described CNC process with the tempered coating layer 420.

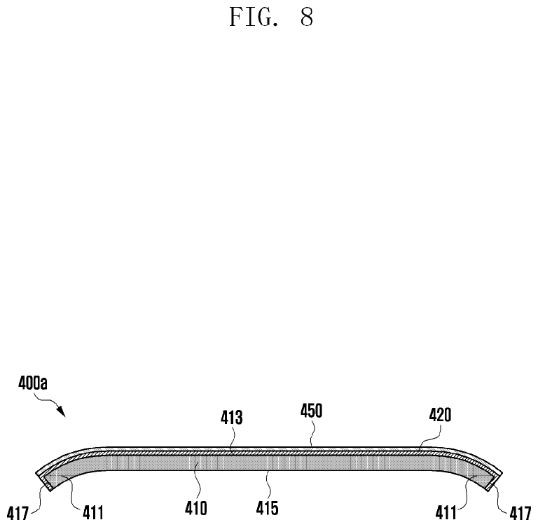

FIG. 8 is a cross-sectional view of a tempered window according to another embodiment of the disclosure.

The tempered window 400a according to another embodiment of the disclosure may further include a contamination preventing coating layer 450. For example, a contamination preventing coating layer 450 may be further formed on the tempered coating layer 420 of the tempered window according to the embodiment of FIG. 5. The contamination preventing coating layer 450 may be an anti-fingerprint (AF) coating layer or an anti-smudge (AS) coating layer that has a water emitting/oil emitting property.

According to the tempered window 400a according to another embodiment of the disclosure, due to the water emitting/oil emitting property of the contamination preventing coating layer 450, contaminants can be easily removed because the contaminants are hardly stuck to a surface of the tempered window or even though the contaminants are struck to the surface of the tempered window.

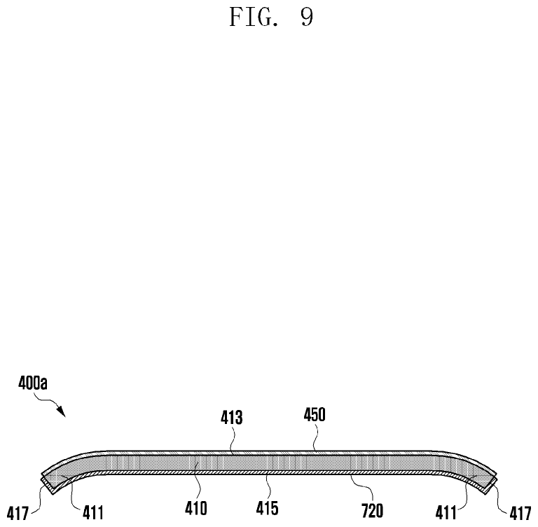

FIG. 9 is a cross-sectional view of a tempered window 400a according to another embodiment of the disclosure.

For example, FIG. 9 may be a view conceptually illustrating a cross-section obtained by cutting the temperature window 400a illustrated in FIG. 4 in a widthwise or lengthwise direction thereof. The widthwise direction may refer to a leftward/rightward direction with respect to the state illustrated in FIG. 4, and the lengthwise direction may refer to an upward/downward direction.

Referring to FIG. 9, the tempered window 400a according to an embodiment of the disclosure may include a window 410 and a tempered coating layer 720.

The tempered window 400a according to an embodiment of the disclosure, as illustrated in FIG. 9, may be configured to surround the second surface 415 and the third surface 417. The tempered coating layer 720 according to an embodiment of the disclosure, as in the case of FIG. 5 which has been described above, may be formed through a dipping scheme of dipping and extracting the window 410 into and from a coating liquid. According to an embodiment, differently from the tempered window 400a illustrated in FIG. 5, the tempered coating layer 720 may be formed on the second surface 413 and the third surface 417 by attaching a masking film 600 (see FIG. 16) to the first surface 413 of the window 410 and removing the masking film 600 (see FIG. 16) after dipping the window 410 into the coating liquid.

The tempered coating layer 720 according to an embodiment of the disclosure may also be adhered and coupled to the curved surface portion of the window 410, and the entire second surface 415 of the window 410 may be coated while the second surface 415 of the window 410 is not exposed whereby the entire window 410 can be reinforced.

The tempered window 400a according to another embodiment of the disclosure may further include a contamination preventing coating layer 450. The contamination preventing coating layer 450 may be formed on the first surface 413 of the window 410. The contamination preventing coating layer 450 may be an anti-fingerprint (AF) coating layer or an anti-smudge (AS) coating layer that has a water emitting/oil emitting property.

The contamination preventing coating layer 450 may be formed prior to the tempered coating layer 720. If the contamination preventing coating layer 450 is formed in the window 410 prior to the tempered coating layer 720, the tempered coating layer 720 may be prevented from being formed on the first surface 413 in the dipping operation for forming the tempered coating layer 720 due to the water emitting/oil emitting property of the contamination preventing coating layer 450 itself.

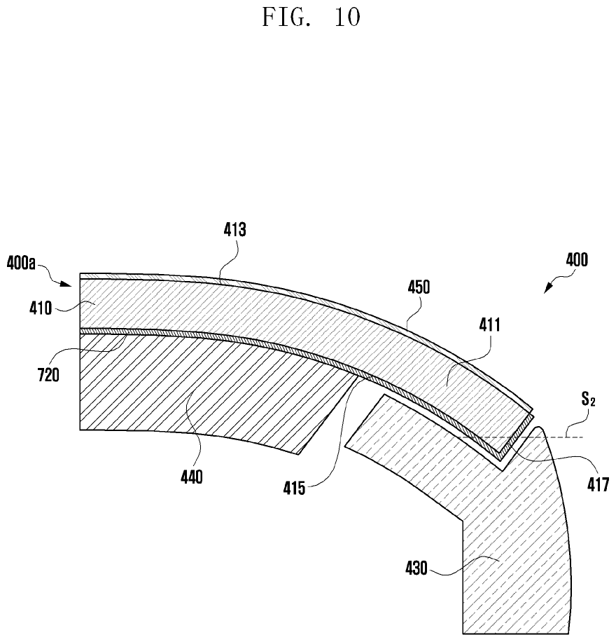

FIG. 10 is a cross-sectional view of an electronic device 400 including a tempered window 400a according to another embodiment of the disclosure.

FIG. 10 may be a view conceptually illustrating a cross-section obtained by cutting the tempered window 400a in the widthwise or lengthwise direction thereof in a state in which the tempered window 400a of FIG. 9 is seated in the housing 430 of the electronic device 400. Referring to FIG. 10, the display 440 may be disposed in a partial area of the second surface 415 of the window 410 according to another embodiment of the disclosure.

The housing 430 of the electronic device 400 according to another embodiment of the disclosure, for example, as in the embodiment of FIG. 6, may be configured to surround a portion of the curved portion of the second surface 415 of the window 410 and the third surface 417.

In a discussion of the formation relationship of the window 410, the tempered coating layer 720, and the housing 430 when an imaginary plane S2 disposed to be parallel to a flat surface of any one of the first surface 413 or the second surface 415 of the window 410 to pass the third surface of the window, the window 410, the tempered coating layer 720, and the housing 430 may be disposed in their sequence. For example, as in the embodiment of FIG. 6, the tempered coating layer 720 may be disposed between the third surface 720 of the window 410 and the housing 430, and the tempered coating layer 720 can perform an absorption function between the window 410 and the housing 430 to absorb an impact delivered to the third surface 417 of the window 410 via the housing 430.

Because the tempered coating layer 720 is formed on the second surface 415 of the window 410 and the contamination preventing coating layer 450 is formed on the first surface 413 of the window 410, the window 410 can be reinforced and can be prevented from being contaminated as well.

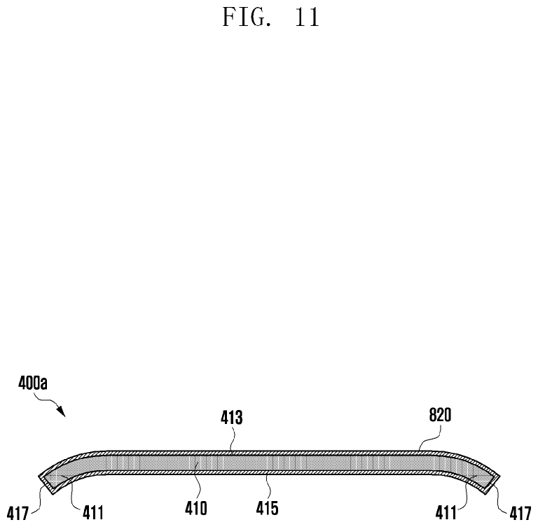

FIG. 11 is a cross-sectional view of a tempered window 400a according to another embodiment of the disclosure.

For example, FIG. 11 may be a view conceptually illustrating a cross-section obtained by cutting the temperature window 400a illustrated in FIG. 4 in a widthwise or lengthwise direction thereof. The widthwise direction may refer to a leftward/rightward direction with respect to the state illustrated in FIG. 4, and the lengthwise direction may refer to an upward/downward direction.

Referring to FIG. 11, the tempered window 400a according to an embodiment of the disclosure may include a window 410 and a tempered coating layer 820.

The tempered window 400a according to an embodiment of the disclosure, as illustrated in FIG. 11, may be configured to surround all of the first surface 413, the second surface 415 and the third surface 417. The tempered coating layer 820 according to an embodiment of the disclosure, for example, as in the embodiment of FIG. 5 which has been described above, may also be formed through a dipping scheme of dipping and extracting the window 410 into and from a coating liquid. However, differently from the case of FIG. 5, the masking film 600 (see FIG. 16) may be dipped into the coating liquid without being attached to the window 410 and thus the tempered coating layer 820 may be formed on all of the first surface 413, the second surface 415, and the third surface 417.

According to another embodiment of the disclosure, the tempered coating layer 820 formed in this way may be adhered and coupled to the curved surface portion of the window 410, and the window 410 can be further reinforced as compared with the case (e.g., the coating layer 420 or 720 of FIG. 5 or FIG. 9) when the entire surface of the window 410 is coated without being exposed.

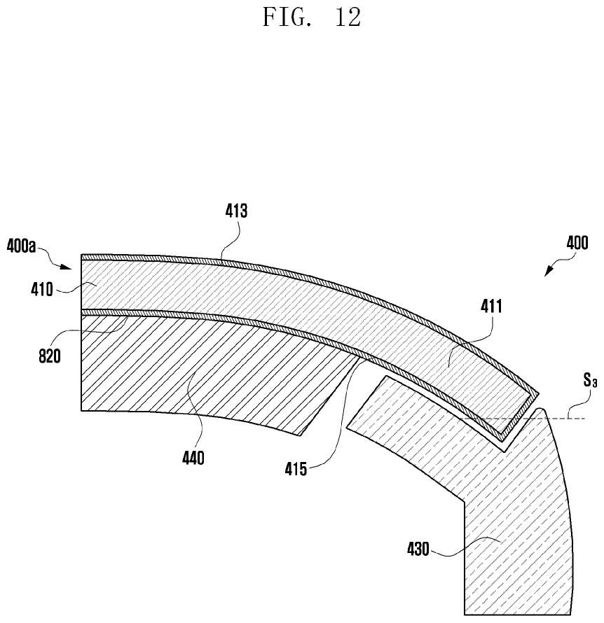

FIG. 12 is a cross-sectional view of an electronic device 400 including a tempered window 400a according to another embodiment of the disclosure.

FIG. 12 may be a view conceptually illustrating a cross-section obtained by cutting the tempered window 400a in the widthwise or lengthwise direction thereof in a state in which the tempered window 400a of FIG. 11 is seated in the housing 430 of the electronic device 400. Referring to FIG. 12, similarly, the display 440 may be disposed in a partial area of the second surface 415 of the window 410 according to another embodiment of the disclosure.

The housing 430 of the electronic device 400 according to another embodiment of the disclosure, for example, as in the embodiment of FIG. 6, may be configured to surround a portion of the curved portion of the second surface 415 of the window 410 and the third surface 417.

According to another embodiment of the disclosure, in a discussion of the formation relationship of the window 410, the tempered coating layer 820, and the housing 430 when an imaginary plane S3 disposed to be parallel to a flat surface of any one of the first surface 413 or the second surface 415 of the window 410 to pass the third surface of the window, the window 410, the tempered coating layer 820, and the housing 430 may be disposed in their sequence. For example, as in the embodiment of FIG. 6, the tempered coating layer 820 may be disposed between the third surface 417 of the window 410 and the housing 430, and the tempered coating layer 820 can perform an absorption function between the window 410 and the housing 430 to absorb an impact delivered to the third surface 417 of the window 410 via the housing 430.

According to another embodiment of the disclosure, the reinforcing effect for the window 410 can be maximized by forming the tempered coating layer 820 on the entire surface of the window 410.

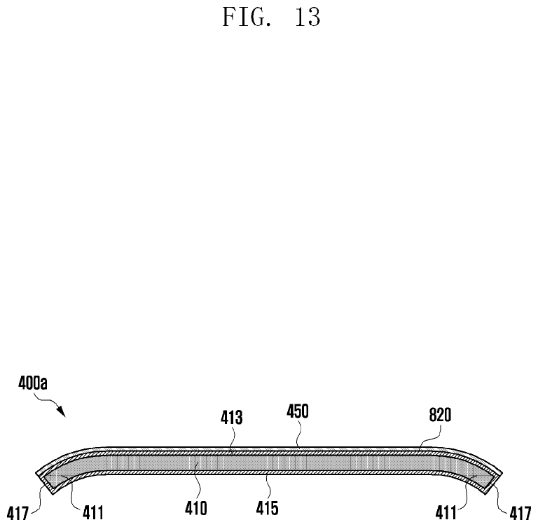

FIG. 13 is a cross-sectional view of a tempered window 400a according to another embodiment of the disclosure.

The tempered window 400a according to another embodiment of the disclosure may further include a contamination preventing coating layer 450. For example, a contamination preventing coating layer 450 may be further formed on the tempered coating layer 820 of the tempered window according to the embodiment of FIG. 11. The contamination preventing coating layer 450 may be an anti-fingerprint (AF) coating layer or an anti-smudge (AS) coating layer that has a water emitting/oil emitting property.

According to the tempered window 400a according to another embodiment of the disclosure, due to the water emitting/oil emitting property of the contamination preventing coating layer 450, contaminants can be easily removed because the contaminants are hardly stuck to a surface of the tempered window or even though the contaminants are struck to the surface of the tempered window.

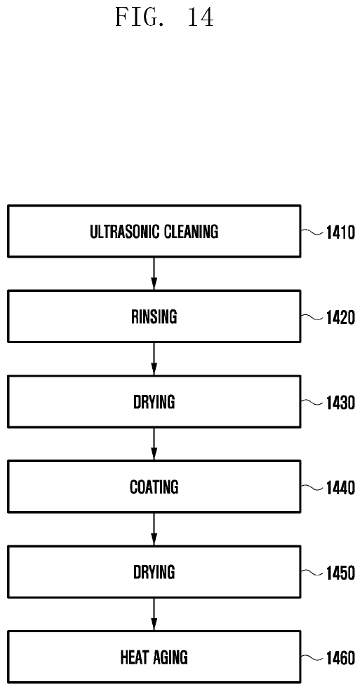

FIG. 14 is a flowchart illustrating a coating operation of a tempered window according to an embodiment of the disclosure.

In operation 1410, an ultrasonic cleaning operation for removing impurities left on the window first may be performed on the window according to an embodiment of the disclosure. The ultrasonic cleaning may be performed for one to three minutes in a temperature range of 50° C. to 100° C. by using a cleaning liquid. The temperature and the time correspond to one embodiment, and the temperature and the time may be changed according to the characteristics and the kind of the used cleaning liquid. In operation 1420, a water rinsing operation of rinsing the window according to an embodiment of the disclosure with water may be performed. In operation 1430, an operation of drying the window according to an embodiment of the disclosure may be performed. In operation 1430, moisture left on the window according to an embodiment of the disclosure may be clearly removed. In operation 1440, a coating operation of dipping the window according to an embodiment of the disclosure in a water vessel in which a coating liquid is contained may be performed. In operation 1450, an operation of drying the window according to an embodiment of the disclosure for about 10 minutes in a range of 50° C. to 100° C. may be performed. In operation 1460, an operation of thermally aging the window according to an embodiment of the disclosure for one to two hours in a range of 150° C. to 250° C. may be performed. The drying temperature, the drying time, the thermal aging temperature, and the thermal aging time may be changed according to the kind and the property of the coating liquid.

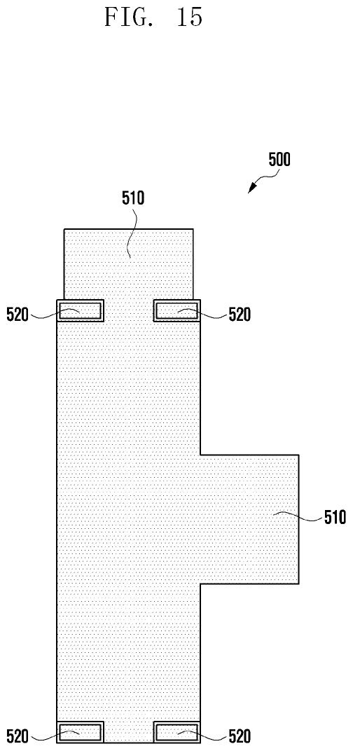

FIG. 15 is a view illustrating a window fixing member 500 according to an embodiment of the disclosure.

The window fixing member 500 may be formed of a hard material, such as a metal or polycarbonate (PC), to prevent the window from being shaken by the flows of the coating liquid in the dipping operation of the window. In a discussion of the window fixing member 500 with reference FIG. 15, four fixing tape attaching parts may be formed, but four fixing tape attaching parts are not essential and the number of the fixing tape attaching parts may be decreased or increased if necessary. The one or more fixing tapes 520 stuck to the fixing tape attaching part may be a tape for attaching the window to the window fixing member 500.

Referring to FIG. 15, a jig fixing part 510 may be disposed in the window fixing member 500 according to an embodiment of the disclosure. The locations and the numbers of the jig fixing parts 510 may also be changed according to the size or shape of the window.

FIG. 16 is a view illustrating a masking tape 610 and a masking film 600 according to an embodiment of the disclosure, and FIG. 16A illustrates the masking tape 610 and FIG. 16B illustrates the masking film 600.

For example, in order to coat the tempered window as in the embodiment of FIG. 5 or FIG. 9, the masking tape 610 and the masking film 600 that may cover the first surface or the second surface of the window may be necessary.

The masking tape 610 may be a tape for attaching the masking film 600 to the window. The masking tape 610 may be a general double-sided tape, and particularly, it may be more advantageous for a dipping process when the masking tape 610 is formed of a tape having a waterproof property. The masking film 600 should be firmly fixed while a contact area between the masking film 600 and the window is minimized because a mark may be left after the masking tape 610 is separated as the masking tape 610 is directly attached to a surface of the window. Accordingly, the masking tape 610 is formed to have a closed curved shape that surrounds only an outermost periphery of the first surface or the second surface of the window.

Referring to FIG. 16A, a rectangular protrusion 611 formed vertically in the shape of the masking tape 610 may correspond to a location at which one or more fixing tapes 520 (see FIG. 15) of the window fixing member 500 (see FIG. 15) is seated. The part may have different shapes and different sizes according to the products. Further, one or more fixing tapes 520 (see FIG. 15) of the window fixing member 500 (see FIG. 15) may be seated in the closed curve of the masking tape 610 without using the protrusion 611. The masking film 600 may be a sheet such as polyethylene terephthalate (PET), and may have the shape and size that are the same as the first surface or the second surface that corresponds to a masking area of the window.

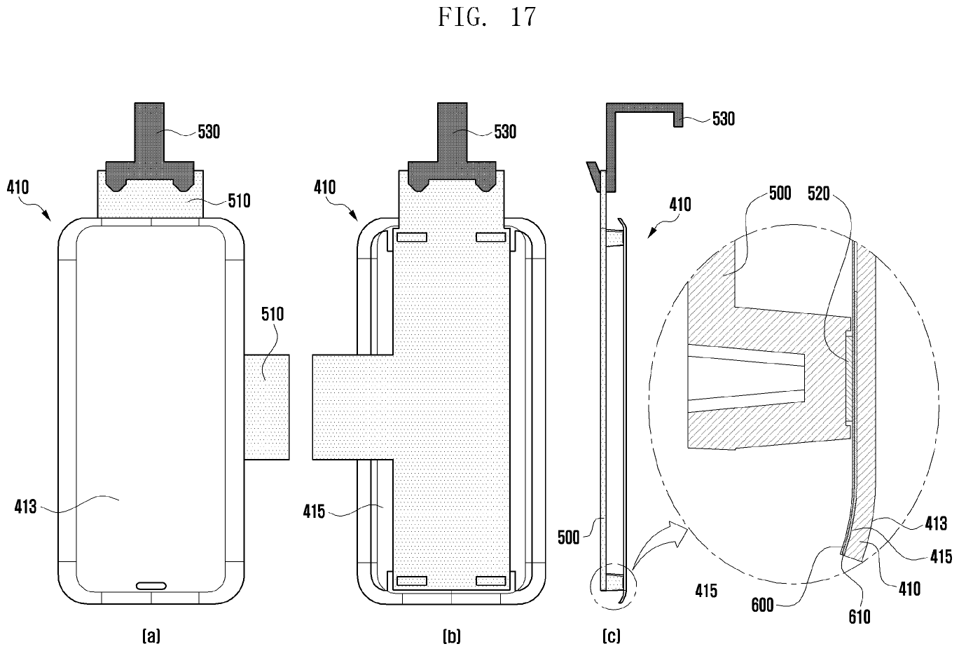

FIGS. 17A to 17C are views illustrating a state in which a window is fixed to a window fixing member 500 to coat the tempered window according to the embodiment of FIG. 5.

FIGS. 17A to 17C may correspond to a shape obtained by attaching the masking tape 610 and the masking film 600 to the second surface 415 of the window and coupling the window fixing member 500 to the masking film 600. Further, the shape may correspond to a shape obtained by coupling even a clamping jig 530 to the jig fixing part 510 of the window fixing member 500. Referring to FIG. 17B, the window 410 is made to stand uprights by coupling the clamping jig 530 to the jig fixing part 510 disposed on the upper side of the window fixing member 500, and the window 410 may be made to be laid horizontally by locating the clamping jig 530 on the left and right sides of the window.

Referring to the enlarged portion of FIG. 17C, a masking tape 610 may be attached to the second surface 415 of the window and a masking film 600 may be attached to a rear surface of the masking tape 610. Further, the window fixing member 500 may be attached to the rear surface of the masking film 600 by using one or more fixing tapes 520. FIG. 17B illustrates four fixing tapes 520, but the number or the shape of the fixing tapes 520 may be changed as described above.

FIG. 17C may correspond to an embodiment for stably attaching the window fixing member 500 to a planar part instead of the curved surface portion of the window 410 by disposing the window fixing member 500 such that the window 410 is introduced from the outside into the inside. This is for stably attaching the window fixing member 500 and the window 410, and may be attached to the curved surface portion of the window.

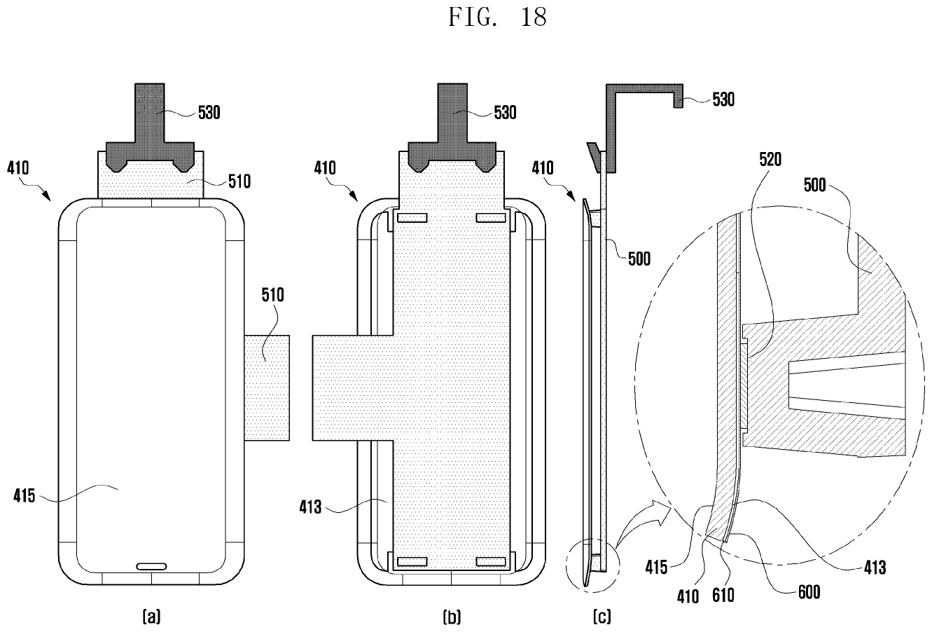

FIGS. 18A to 18C are views illustrating a state in which a window 410 is fixed to a window fixing member 500 to coat the tempered window according to the embodiment of FIG. 9.

For example, this embodiment is different from the case of FIG. 17 in that the attachment locations of the masking tape 610 and the masking film 600 are changed to the first surface 413 instead of the second surface 415 of the window.

FIG. 18B also illustrates fourth fixing tapes, but as described above, the number or the shape of the fixing tapes may be changed, and the fixing tapes may be attached to the planar portion or the curved surface portion of the window 410.

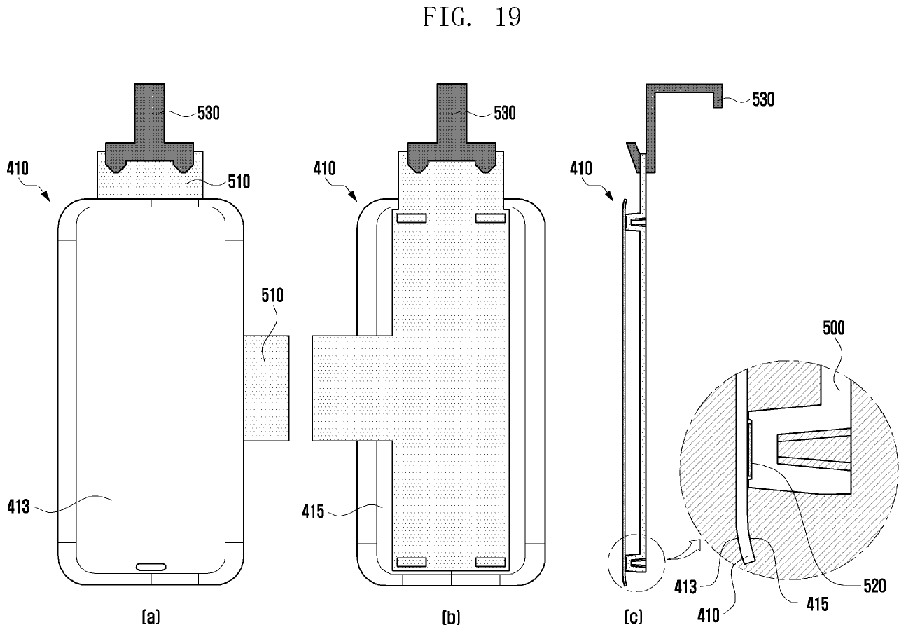

FIG. 19 is a view illustrating a state in which a window 410 is fixed to a window fixing member 500 to coat the tempered window according to the embodiment of FIG. 11.

When the tempered coating layer is formed on all surfaces of the window 410 as in the case of FIG. 11, a masking film may not be attached and the window fixing member 500 may be directly attached to the window 410. If the window fixing member 500 is directly attached to the window 410, a coating liquid may not be stuck to the portion of the window 410, to which the window fixing member 500 is attached in the dipping operation.

Further, in the operation of extracting the window 410 from the coating liquid, flow marks of the coating liquid may be generated around the portion, to which the fixing tape 520 of the window fixing member 500 is attached. Accordingly, the window fixing member 500 may be designed to be attached to an area in which the flow marks are not viewed from the outside. For example, the window fixing member 500 may be prevented from being viewed from the outside even when a flow mark is generated by attaching the window fixing member 500 to a black mask (BM) area of the electronic device.

An electronic device according to an embodiment of the disclosure may include a window having a curved surface at a corner thereof, a housing in which the window is seated, and a tempered coating layer surrounding at least a partial surface of the window, wherein the window may include a first surface in contact with a user, a second surface that is opposite to the first surface, and a third surface connecting the first surface and the second surface, wherein the housing may be disposed to cover the third surface of the window, wherein the tempered coating layer may be disposed to surround at least the third surface of the window.

When imaginary surface that is parallel to a flat portion of the window is located to pass through the third surface of the window, the imaginary surface may extend from the center of the electronic device to the outer side, and may sequentially pass through the window, the tempered coating layer, and the housing.

The tempered coating layer may be disposed to surround both the first surface and the third surface of the window, and when imaginary surface that is parallel to a flat portion of the window is located to pass through the third surface of the window, the imaginary surface may extend from the center of the electronic device to the outer side, and may sequentially pass through the window, the tempered coating layer, and the housing.

The tempered coating layer may be disposed to surround both the second surface and the third surface of the window, when imaginary surface that is parallel to a flat portion of the window is located to pass through the third surface of the window, the imaginary surface may extend from the center of the electronic device to the outer side, and may sequentially pass through the window, the tempered coating layer, and the housing.

The tempered coating layer may be disposed to surround all of the first surface, the second surface, and the third surface of the window, and when imaginary surface that is parallel to a flat portion of the window is located to pass through the third surface of the window, the imaginary surface may extend from the center of the electronic device to the outer side, and may sequentially pass through the window, the tempered coating layer, and the housing.

The tempered coating layer may be disposed to surround both the second surface and the third surface of the window, the electronic device may further include a contamination preventing coating layer surrounding the first surface of the window, and when imaginary surface that is parallel to a flat portion of the window is located to pass through the third surface of the window, the imaginary surface may extend from the center of the electronic device to the outer side, and may sequentially pass through the window, the tempered coating layer, and the housing.

The contamination preventing coating layer may be formed in the window before the tempered coating layer is formed.

The window may include a fourth surface formed by machining a corner defined by the first surface and the third surface, and a fifth surface formed by machining a corner defined by the second surface and the third surface.

The tempered coating layer may be disposed to surround all of the first surface, the third surface, the fourth surface, and the fifth surface of the window.

The window may be formed of heat-treated tempered glass.

A tempered window according to an embodiment of the disclosure may include a window having a curved portion at an outer portion thereof, and a tempered coating layer surrounding at least a portion of a surface of the window, wherein the window may include a first surface in contact with a user, a second surface that is opposite to the first surface, and a third surface connecting the first surface and the second surface, wherein the tempered coating layer may be disposed to surround at least the third surface of the window.

The tempered coating layer may be disposed to surround both the first surface and the third surface of the window.

The tempered coating layer may be disposed to surround both the second surface and the third surface of the window.

The tempered coating layer may be disposed to surround all of the first surface, the second surface, and the third surface of the window.

The tempered window may further include a contamination preventing coating layer surrounding the first surface of the window.

The contamination preventing coating layer may be formed in the window before the tempered coating layer is formed.

The window may include a fourth surface formed by machining a corner defined by the first surface and the third surface, and a fifth surface formed by machining a corner defined by the second surface and the third surface.

The tempered coating layer may be disposed to surround all of the first surface, the third surface, the fourth surface, and the fifth surface of the window.

The window may be formed of heat-treated tempered glass.

1. An electronic device comprising:
a window;
a housing in which the window is seated; and
a tempered coating layer surrounding at least a portion of a surface of the window,
wherein the window comprises:
a first surface exposed to the outside;
a second surface that is opposite to the first surface; and
a third surface connecting the first surface and the second surface,
wherein the housing is disposed to hide at least a portion of the third surface, and
wherein the tempered coating layer is disposed to surround at least the third surface of the window.

2. The electronic device of claim 1, wherein, when an imaginary surface that is parallel to a flat portion of the window is located to pass through the third surface of the window, the imaginary surface extends from the center of the electronic device to the outer side, and sequentially passes through the window, the tempered coating layer, and the housing.

3. The electronic device of claim 1, wherein the tempered coating layer is disposed to surround both the first surface and the third surface of the window, and
wherein, when imaginary surface that is parallel to a flat portion of the window is located to pass through the third surface of the window, the imaginary surface extends from the center of the electronic device to the outer side, and sequentially passes through the window, the tempered coating layer, and the housing.

4. The electronic device of claim 1, wherein the tempered coating layer is disposed to surround both the second surface and the third surface of the window,
wherein, when imaginary surface that is parallel to a flat portion of the window is located to pass through the third surface of the window, the imaginary surface extends from the center of the electronic device to the outer side, and sequentially passes through the window, the tempered coating layer, and the housing.

5. The electronic device of claim 1, wherein the tempered coating layer is disposed to surround all of the first surface, the second surface, and the third surface of the window,
wherein, when imaginary surface that is parallel to a flat portion of the window is located to pass through the third surface of the window, the imaginary surface extends from the center of the electronic device to the outer side, and sequentially passes through the window, the tempered coating layer, and the housing.

6. The electronic device of claim 1, wherein the tempered coating layer is disposed to surround both the second surface and the third surface of the window,
wherein the electronic device further comprises a contamination preventing coating layer surrounding the first surface of the window, and
wherein, when imaginary surface that is parallel to a flat portion of the window is located to pass through the third surface of the window, the imaginary surface extends from the center of the electronic device to the outer side, and sequentially passes through the window, the tempered coating layer, and the housing.

7. The electronic device of claim 6, wherein the contamination preventing coating layer is formed in the window before the tempered coating layer is formed.

8. The electronic device of claim 1, wherein the tempered coating layer is disposed to surround both the first surface and the third surface of the window, and
wherein the electronic device further comprises a contamination preventing coating layer stacked on the tempered coating layer surrounding the first surface.

9. The electronic device of claim 1, wherein the tempered coating layer is disposed to surround all of the first surface, the second surface, and the third surface of the window, and
wherein the electronic device further comprises a contamination preventing coating layer stacked on the tempered coating layer surrounding the first surface.

10. The electronic device of claim 1, wherein the window comprises:
a fourth surface formed by machining a corner defined by the first surface and the third surface; and
a fifth surface formed by machining a corner defined by the second surface and the third surface.

11. The electronic device of claim 10, wherein the tempered coating layer is disposed to surround all of the first surface, the third surface, the fourth surface, and the fifth surface of the window.

12. The electronic device of claim 1, wherein the window is formed of heat-treated tempered glass.

13. The electronic device of claim 1, wherein the window has a curved portion at a corner portion thereof.

14. A tempered window comprising:
a window having a curved portion at an outer portion thereof; and
a tempered coating layer surrounding at least a portion of a surface of the window,
wherein the window comprises:
a first surface, to which a manipulation of a user is input;
a second surface that is opposite to the first surface; and
a third surface connecting the first surface and the second surface,
wherein the tempered coating layer is disposed to surround at least the third surface of the window.

15. The tempered window of claim 14, further comprising:
a contamination preventing coating layer surrounding the first surface of the window.
